(19) United States
(12) Patent Application Publication
(10) Pub. No.: US 2017/0228484 A1
(43) Pub. Date: Aug. 10, 2017

(54) SYSTEM AND METHOD FOR LAYOUT SIMPLIFICATION

(71) Applicant: TEXAS INSTRUMENTS INCORPORATED, DALLAS, TX (US)

(72) Inventors: BRIAN P. GINSBURG, ALLEN, TX (US); EUNYOUNG SEOK, ALLEN, TX (US)

(73) Assignee: Texas Instruments Incorporated, DALLAS, TX (US)

(21) Appl. No.: 15/019,671

(22) Filed: Feb. 9, 2016

(51) Int. Cl. G06F 17/50

(52) U.S. Cl. CPC G06F 17/5045; G06F 17/5022

(57) ABSTRACT

A system and method is disclosed for verifying semiconductor circuit layouts. A resistor stick network model of the semiconductor circuit layout is generated from a low frequency extraction of the circuit. The resistor stick network then can be used to determine open or short in the circuit by comparing the pairwise terminal resistance of each circuit node thus eliminating open/short failures in the circuit.

### TECHNICAL FIELD

This disclosure relates generally to the field of semiconductor circuit designs, in particular to the simulation of semiconductor circuit layout.

### BACKGROUND

Typically, semiconductor circuit layouts are tested and verified using various simulation techniques to detect and correct design errors prior to releasing the design into production. Electromagnetic (“EM”) simulators are generally used to capture inductive distributed effects of large scale networks. Most EM simulators partition (mesh) the circuit layout to define unit cells for a particular given solver algorithm. Deep submicron CMOS processes require complex layouts with many small scale features (e.g., via arrays, slots, metal fill, and the like) to meet design rules. Complete modeling of these features significantly increase the number of mesh elements, which makes simulations long and sometime it may not be possible to simulate certain layouts. Further, complete modeling of various features is sometime unnecessary and uses up resources because many of these features can be treated in aggregate or ignored.

Circuit layouts in advanced process nodes (e.g., deep submicron CMOS) are too complex to be efficiently simulated in an EM simulator therefore, certain simplifications in the designs layout are required before the simulation. The simplification allows circuit designers to incrementally adjust the parameters of circuit design during the design process. Some examples of simplifications include merging slots or stripes of the same net, merging vias, eliminating or approximating fill, smoothing edges, and the like.

For certain EM structures, such as transformer or inductor windings, desired connectivity can be incorporated in the layout using metal resistors and representing those in the layout; however, this representation does not work for ground planes. The EM layouts usually use additional pins in the circuit layouts to match the distributed ground that cannot be cleanly separated using automated tool. Automated simplifications within a tool cannot be checked as the simplified layouts are not typically exportable to a flow. Therefore, manual simulations of the output S-parameters are performed; however, manual simplifications are prone to errors including but not limited to accidentally causing a short or an open in the circuit layout. Manual simulations do not detect unintended open that is simplified to the desired short, which can result in catastrophic consequences during device operation.

### SUMMARY

In accordance with an embodiment an apparatus is disclosed. The apparatus includes a circuit design unit configured to generate a circuit design layout, a simplified representation of the circuit design layout, and a low frequency extraction module coupled to the circuit design unit and configured to generate S-parameter model of one or more of the circuit design layout, the simplified representation of the circuit design layout, and the metal shape representation; and a resistor net list generation module coupled to the low frequency extraction module and configured to generate resistor based netlist of the S-parameter mode.

In accordance with another embodiment, a method is disclosed. The method includes generating a S-parameter model of a circuit design layout, the circuit design layout comprising one or more circuit ports, determining admittance parameters for each one of the S-parameter for the one or more of the circuit ports, determining whether the admittance parameter for one or more of the circuit ports in the circuit design layout is greater than a predetermined threshold conductance, and generating a resistor netlist representing the circuit design layout if the admittance parameter for the one or more of the circuit port is greater than a predetermined threshold conductance.

In accordance with yet another embodiment, a system is disclosed. The system includes, a circuit design unit, a low frequency extraction module coupled to the circuit design unit, a resistor net list generation module coupled to the low frequency extraction module and configured to generate resistor based netlist of a S-parameter model of the circuit design layout, a connectivity check module coupled to the resistor netlist generation module and configured to compare the resistor based netlist with a design intent resistor netlist, and generate a representation of the circuit design layout identifying one or more of circuit open and circuit shorts in the circuit design layout.

### BRIEF DESCRIPTION OF THE DRAWINGS

FIG. 1 is an exemplary system flow for verifying circuit simplification consistency according to an embodiment.

FIG. 2 is an exemplary resistor string schematic of a transformer according to an embodiment.

FIG. 3 illustrates an exemplary flow diagram of a process for generating resistor netlist according to an embodiment.

FIG. 4 illustrates an exemplary system for layout simplification using resistor based netlist according to another exemplary embodiment.

### DETAILED DESCRIPTION

The following description provides many different embodiments, or examples, for implementing different features of the subject matter. These descriptions are merely for illustrative purposes and do not limit the scope of the invention.

According to an embodiment, a system and method is disclosed for circuit extraction using resistor based netlist. Conventional circuit extraction methods generate S-parameters for electromagnetic simulation. Typically, S-parameter based circuit extractions cannot distinguish among various circuit elements for example, vias in the circuit can be considered as open circuit and similarly, manufacturing holes can be mistaken for vias. This can result in simulation method mistakenly shortening the open circuit and opening certain connections causing the malfunction of the circuit. According to an embodiment, resistor based netlist of circuit extractions allow comparison of pairwise terminal resistance with a simplified extraction generated by a simulation tool using the S-parameter and identify and fix errors caused by erroneous circuit shorts or circuit open.

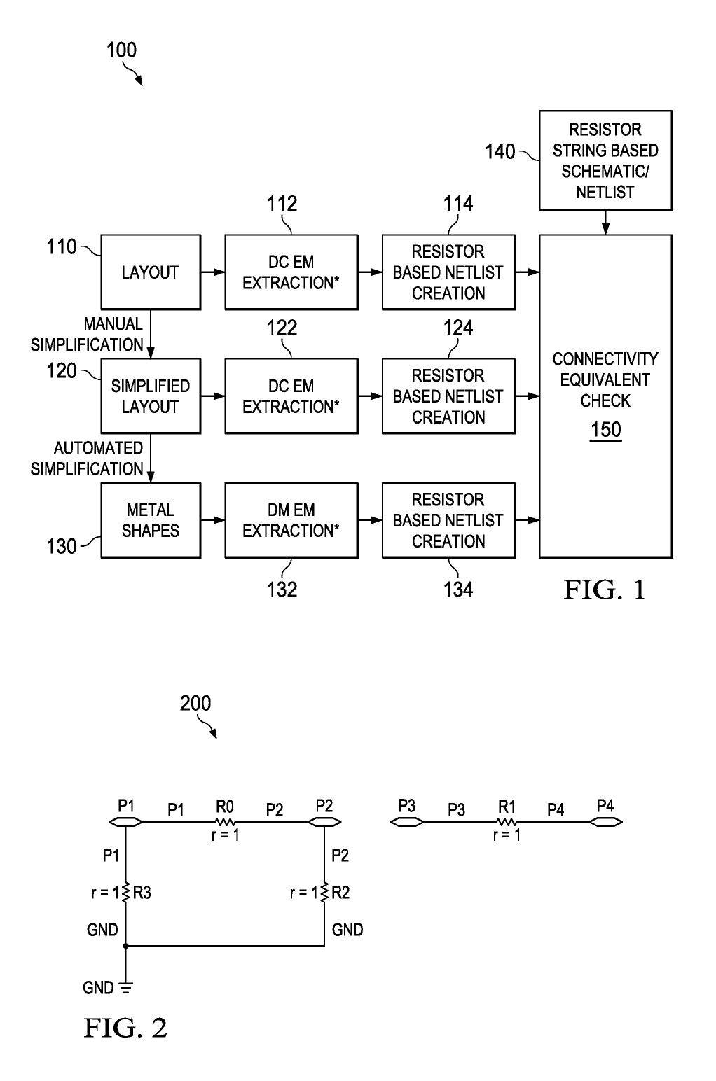

FIG. 1 illustrates an exemplary system flow 100 for verifying circuit simplification consistency according to an embodiment. The circuit layout 110 is the intended circuit design of a device. The circuit layout 110 is used to generate a manually simplified layout 120. The manually simplified layout 120 can be generated by examining the circuit and output S-parameters. The connectivity errors typically are caught by happenstance. This does not catch an unintended open that is simplified to the desired short. The simplified layout is then used to generate metal shapes with conductor properties using simulation tools known in the art. The circuit layout 110, simplified layout 120, and the metal shapes 130 are processed through a DC or low frequency circuit extraction process 112, 122, and 132 respectively. Conventionally, DC/low frequency extraction generates S-parameter or Resistor-Inductance-Capacitance (RLC) models for electromagnetic simulation. As stated hereinabove, simplifications may cause errors by creating circuit shorts or open. According to an embodiment, the DC/low frequency extraction processes 112, 122, and 132 generate resistor based netlists 114, 124, and 134 respectively for each of the layouts. Resistor based netlist models generate accurate representation of circuit layout that can be compared to determine circuit errors. A connectivity equivalent check module 150 compares each resistor based netlist to determine inconsistencies in each layout.

According to another embodiment, an optional resistor string based schematic/netlist 140 can be provided to the connectivity equivalent check module 150. The resistor string based netlist 140 represents design intent of the original circuit layout, which provides a benchmark for the connectivity equivalent check module 150 to identify any deviations from the original design intent. The connectivity of all low frequency extraction are compared to each other and also compared to designer intent supplied resistor string. The connectivity may be simple pairwise connectivity with a reasonable value of resistance indicating a short.

FIG. 2 illustrates an exemplary resistor string schematic 200 of a transformer according to an embodiment. Primary windings of the transformer are represented by P1 and P2. The center tap of the primary winding is grounded. Each winding is represented by a respective resistor R0, R2, and R3. The secondary winding of the transformer is represented by P3 and P4 where the winding itself is modeled by resistor R1. The resistor string schematic 200 can be used by, for example, connectivity equivalent check module 150 to compare a layout with design intent to verify simplicity consistency to ensure that the layout simplification for simulation does not accidently short/open any connection.

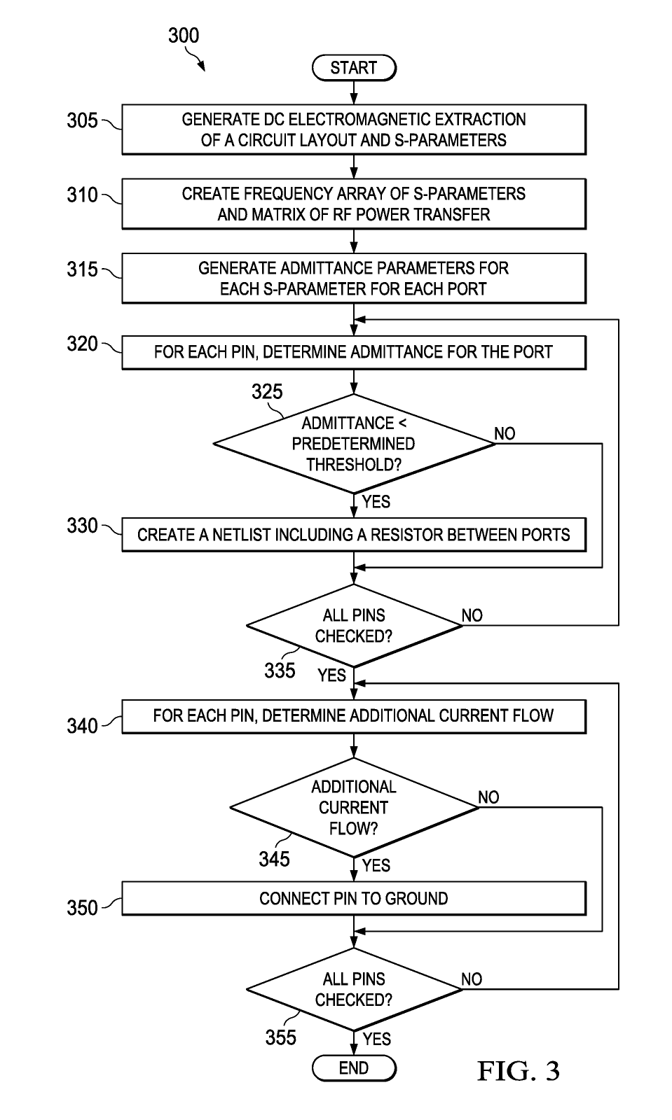

FIG. 3 illustrates an exemplary flow diagram 300 of a process for generating resistor netlist according to an embodiment. Initially, at 305, a DC or low frequency extraction of the circuit layout is created including the S-parameter list for each node. The S-parameter list can be generated using various known methods such as for example by using EM simulators. According to an embodiment, the S-parameter list can be generated using a known format such as for example Touchstone format or the like. At 310, a list of frequency array of S-parameters (a matrix of RF power transfer) is generated. These lists include a frequency array of S-parameters, where for each frequency the S-parameters ultimately form a matrix describing the RF power transfer between ports. The DC/low frequency extraction can be generated using the lowest frequency point from the list.

At 315, the admittance parameter or Y-parameter, for each S-parameter is generated. Admittance parameter or Y-parameter describe the electrical behavior of linear electrical network of the circuit layout. For example, a system with n ports, it is an n x n matrix. The parameter Y(i,j) corresponds to the current seen on port i when port j is driven by a unity voltage source and all other ports are grounded. Y-parameters are calculated deterministically from the s-parameters using known methods. At 320, the process then determines the admittance of each port at each pin based on the calculated Y-parameter and at 325 compares it to a predetermined threshold resistance.

The predetermined threshold resistance (R)can be any impedance/resistance of each port. According to an embodiment, the predetermined threshold is selected higher than the largest expected resistance seen in a typically connected metal system for example, less than 100 ohms and lower than the resistance that can be present due to numerical limitations of EM simulators for example in the Giga-ohm range. If a given circuit layout does not include intentionally long metal line with high resistance, then a default value of 10 k-ohm can also be used; however, this value can be adjusted based on given circuit structures. In an embodiment, the admittance parameters (Y-parameters) can be converted to impedance values (Z=1/Y) before comparing the admittance parameters with the predetermined resistance R. In yet another embodiment, the admittance parameter can be compared with a predetermined conductance G to determine whether the admittance parameter is greater than the predetermined threshold conductance G, where G=1/R. If the admittance at the given pin is less than the predetermined threshold, then at 330, a schematic or netlist is created, which is another representation of the circuit that includes the resistors (e.g., 1 ohm resistor or the like). At 335 the process determines if the admittance of all the pins have been evaluated and if admittance of all the pins have not been evaluated, then the process continues at 320 until the admittance of all pins in the layout have been evaluated against the predetermined threshold. The process of evaluating admittance of each pin can be mathematically represented as:
For each i;
j<Nₚᵢₙₛ where i≠j;
if 1/Y(i,j)<R_{threshold}, connect a resistor between pin i and j.
where Nₚᵢₙₛ is the number of pins in the circuit layout.

At 340 when all pins in the circuit layout have been evaluated for admittance, the process determines the possibility of additional current flow through all the pins after adding resistors. If there is a possibility of additional current flow at node i, then the process at 350 connects the pin to ground and continues to check all the pins at 355 to make sure each pin has been evaluated for additional current. The process of evaluating additional current through each node/pin can be mathematically represented as:

[1/{Y(i,i)+Σj≠i Y(i,j)}]>R_{threshold}; connect a resistor between pin i and the ground.

As illustrated in the equation above, 1/(Y(i,i)) is the current flowing into the pin. The sum of all Y(i,j) is the currents flowing out of the pin to all the other (non-ground) ports. Thus, when adding all together, the current going into port i, that does not end up at any other port j, can be determined. That current, if present, indicates that it is going to ground. Y(i,j) is the current that exits node i when node j is excited by a voltage, that means if current is present (the resistance is low), then these nodes are connected. If no current is present, Y(i,j)˜0, and 1/Y(i,j)>>Rthreshold, then these nodes are not connected. For Y(i,i), port i is driven by a voltage source and all other nodes are grounded. By summing Y(i,j) (for all j i) and Y(i,i), all of the current going to other nets is cancelled. If additional current flows into node i that is not exiting at nodes j, then there can be a connection between node i and ground. Once all connections for addition ports are made, the layout is represented by a resistor netlist, which can be analyzed and simulated without causing short (or open) as it is in the case of the layout simplification that causes the unintentional short or open. With resistor netlist process, the DC connectivity is maintained across manual and automatic layout simplifications, including correlation to designer intent, which eliminates catastrophic open/short failures as in the case of conventional S-parameter analysis and minimizes iterations through full EM simulation on incorrect layouts.

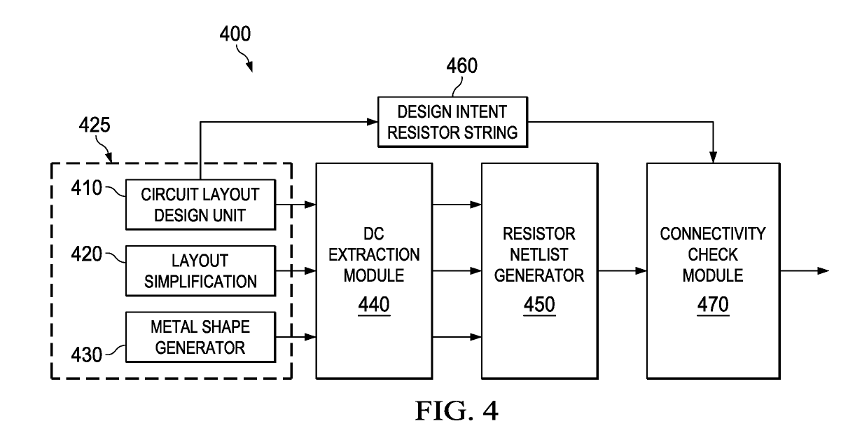

FIG. 4 illustrates an exemplary system 400 for verification of layout simplification using resistor based netlist according to an embodiment. The circuit layout design unit 410 generates a circuit layout based on a circuit design developed by a circuit designer. The circuit layout generator can be any known available layout design tool. The circuit layout generated by the circuit layout design unit 410 can then be manually or automatically simplified using tools available in the circuit layout design unit 410. For manual simplification, a circuit designer can use any user interface available in the circuit layout design unit such as keyboard, display, and other user interface related associated units (not shown for simplification). The circuit layout can then be processed by metal shape generator 430 to generate metal representation of circuit elements and nets. The metal shape generator 430 can be any automated simplification step, which is typically embedded in the EM analysis tool.

While individual units such as units 410, 420, and 430 are illustrated for exemplary purposes; however, one skilled in the art will appreciate that these modules and units can be integrated in a design tool unit 425 (shown in dashed lines). Each individual unit can exchange data with the other unit and use the output of the other unit to generate the desired simplification layout. The design tool unit 425 can also include each of these individual modules as separate hardware units such a microcontrollers, individual special purpose circuit boards, or the like or these modules can be implemented as software modules using various circuit design software languages or can be integrated in a hardware or software unit or combination thereof.

A DC/low frequency Extraction module 440 generates DC equivalents (direct DC or extrapolated) of each simplification step of the circuit design as explained hereinabove with reference to FIG. 1. The resistor netlist generator 450 generates resistor netlists for each circuit net as shown and described with reference to FIG. 2. The resistor netlists generated by the resistor netlist generator 450 is compared by the connectivity check module 470 for equivalency between resistor netlists provided by the resistor netlist generator 450 for each DC extraction of layout simplification and optionally against the original design intent resistor string list provided by the optional design intent resistor string unit 460. The design intent resistor string list unit 460 can be an integrated module in the unit 425 or can be an independent computing unit configured to use the original design and generate a resistor string list of the original design. The connectivity check module 470 can be an independent hardware unit, an integrated module in the unit 425, or a software module implemented in any of the units in system 400. Depending on the complexity of the circuit, the design intent resistor string list can be prepared manually by the designer and provided to connectivity check module 470 using various user interfaces such as keyboard, scanners, electronic design output file, and the like. The connectivity check module 470 generates a final simplification layout using resistor based netlist circuit extractions that allows comparison of pairwise terminal resistance with a simplified extraction and identify errors caused by erroneous circuit short or circuit open.

The foregoing outlines features of several embodiments so that those of ordinary skill in the art may better understand various aspects of the present disclosure. Those of ordinary skill in the art should appreciate that they may readily use the present disclosure as a basis for designing or modifying other processes and structures for carrying out the same purposes and/or achieving the same advantages of various embodiments introduced herein. Those of ordinary skill in the art should also realize that such equivalent constructions do not depart from the spirit and scope of the present disclosure, and that they may make various changes, substitutions, and alterations herein without departing from the spirit and scope of the present disclosure.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims. Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Moreover, “exemplary” is used herein to mean serving as an example, instance, illustration, etc., and not necessarily as advantageous. Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. An apparatus comprising:
a circuit design unit configured to generate
a circuit design layout,
a simplified representation of the circuit design layout, and a low frequency extraction module coupled to the circuit design unit and
configured to generate S-parameter model of one or more of the circuit design layout, the simplified representation of the circuit design layout, and the metal shape representation; and
a resistor net list generation module coupled to the low frequency extraction module and configured to generate resistor based netlist of the S-parameter model.

2. The apparatus of claim 1, further comprising:
a connectivity check module coupled to the resistor netlist generation module and configured to
compare the resistor based netlist with a design intent resistor netlist, and
generate a representation of the circuit design layout identifying one or more of circuit open and circuit shorts in one or more of the circuit design layout or the simplified representation of the circuit design layout.

3. The apparatus of claim 1, further comprising:
a design intent resistor netlist generator coupled to the connectivity check module and configured to generate the design intent resistor netlist.

4. The apparatus of claim 3, wherein the low frequency extraction module, the resistor netlist generation module, and the connectivity check module are integrated in the circuit design unit.

5. A method comprising:
generating a S-parameter model of a circuit design layout, the circuit design layout comprising one or more circuit ports;
determining admittance parameters for each one of the S-parameter for the one or more of the circuit ports;
determining whether the admittance parameter for one or more of the circuit ports in the circuit design layout is greater than a predetermined threshold conductance; and
generating a resistor netlist representing the circuit design layout if the admittance parameter for the one or more of the circuit port is greater than a predetermined threshold conductance.

6. The method of claim 5, wherein the resistor netlist comprises one or more of:
a resistor coupled between one or more ports of the circuit layout, and a resistor couple between the one or more ports of the circuit layout and a ground plane.

7. The method of claim 6, further comprising:
determining whether each one of the resistor for the one or more of the circuit port generates additional current flow in the circuit; and
connecting the one or more of the circuit ports to the ground plane if the one of the resistor for the one or more of the circuit port generates additional current flow in the circuit.

8. The method of claim 5, wherein the S-parameter model of the circuit design layout is generated by a low frequency extraction of the circuit design layout.

9. The method of claim 7, further comprising:
comparing the resistor based netlist of the circuit design layout with a design intent resistor netlist; and
generating a representation of the circuit design layout identifying one or more of circuit open and circuit shorts in the circuit design layout and a simplified circuit layout.

10. The method of claim 5, wherein the predetermined threshold resistance is one of
less than or equal to 100 ohm, and
less than or equal to 10 kilo-ohms.

11. A system comprising:
a circuit design unit;
a low frequency extraction module coupled to the circuit design unit;
a resistor net list generation module coupled to the low frequency extraction module and configured to generate resistor based netlist of a S-parameter model of the circuit design layout;
a connectivity check module coupled to the resistor netlist generation module and configured to
compare the resistor based netlist with a design intent resistor netlist, and
generate a representation of the circuit design layout identifying one or more of circuit open and circuit shorts in the circuit design layout.

12. The system of claim 11, further comprising:
a design intent resistor netlist generator coupled to the connectivity check module and configured to generate the design intent resistor netlist.

13. The system of claim 11, wherein the circuit design unit is configured to generate a circuit design layout, a simplified representation of the circuit design layout, and a metal shape representation of each element of the circuit design layout.

14. The system of claim 13, wherein the low frequency extraction module is configured to generate the S-parameter model of one or more of the circuit design layout, the simplified representation of the circuit design layout, and the metal shape representation of the each element of the circuit design layout
